(19) United States
(12) Patent Application Publication
(10) Pub. No.: US 2013/0275878 A1
(43) Pub. Date: Oct. 17, 2013

(54) METHOD, DEVICE, SERVER, AND MOBILE TERMINAL FOR BROWSING WEB PAGES

(71) Applicant: Tencent Technology (Shenzhen) Company Limited, Shenzhen City (CN)

(72) Inventors: Shudong Ruan, Shenzhen City (CN); Yu Xu, Shenzhen City (CN); Guangyu Yang, Shenzhen City (CN); Mo Peng, Shenzhen City (CN)

(21) Appl. No.: 13/912,686

(22) Filed: Jun. 7, 2013

Related U.S. Application Data
(63) Continuation of application No. PCT/CN2011/078084, filed on Aug. 5, 2011.

(30) Foreign Application Priority Data
Dec. 13, 2010 (CN) 201010592253.4

(51) Int. Cl. H04L 12/24

(52) U.S. Cl. CPC H04L 41/0253
USPC 715/738

(57) ABSTRACT

The present invention, pertaining to the field of communications technologies, discloses a method, device, server, and mobile terminal for browsing web pages. The method includes: acquiring a web page requested by a user terminal; dividing the web page into at least two subpages when the number of bytes on the web page requested by the user terminal is larger than the number of bytes per subpage as predetermined by the user terminal; and sending a first subpage of the at least two subpages to the user terminal, and sending the link(s) of the subpage(s) other than the first subpage to the user terminal, so that the user terminal browses the web page according to the first subpage and the link(s). The device includes: a first acquiring module, a page dividing module, and a sending module. The mobile terminal includes: a sending module, a receiving module, and a browsing module. The present invention improves the browsing speed and operation speed, but also saves network traffic of the mobile terminal.

### CROSS-REFERENCE TO RELATED APPLICATIONS

This application is a continuation application of, and claims the benefit of priority under 35 U.S.C. §120 to, PCT/CN2011/078084 filed on Aug. 15, 2011 and titled “METHOD, DEVICE, SERVER, AND MOBILE TERMINAL FOR BROWSING WEB PAGES”, which claims priority to Chinese Patent Application No. 201010592253.4, filed on Dec. 13, 2010 and entitled “METHOD, DEVICE, SERVER, AND MOBILE TERMINAL FOR BROWSING WEB PAGES”, both of which are hereby incorporated herein by reference in their entireties for all purposes.

### FIELD OF THE INVENTION

The present invention relates to the field of network communications, and in particular, to a method, device, server, and mobile terminal for browsing web pages.

### BACKGROUND OF THE INVENTION

With the popularity of asymmetric digital subscriber lines (ADSLs) and the improvement of computing capabilities of personal computers (PCs), web page content displayed on the Internet becomes more abundant and diverse. Accordingly, the number of bytes, including hypertext markup language (HMTL) and pictures, on the web page is becoming larger and larger. When browsing web pages using mobile terminals, users typically download the web pages entirely, and the web pages are displayed on the mobile terminals.

After analysis on the prior art, the inventors find that the prior art has at least the following disadvantages:

When a web page is browsed, a single web page may include HTML content cascading style sheets (CSS), JavaScript (JS), and pictures, and the bytes contained thereon may be oversized. Consequently, a large amount of memory and central processing unit (CPU) of the mobile terminal of an operating system is occupied, thereby affecting the browsing speed and operation speed of the user and wasting network traffic of the mobile terminal.

### SUMMARY OF THE INVENTION

Embodiments of the present invention provide a method, device, server, and mobile terminal for browsing web pages, to improve browsing speed and operation speed of users, and save network traffic for mobile terminals.

In one aspect, a method for browsing web pages is provided, including:

acquiring a web page requested by a user terminal;

dividing the web page into at least two subpages when the number of bytes on the web page requested by the user terminal is larger than the number of bytes per subpage as predetermined by the user terminal; and

sending a first subpage of the at least two subpages to the user terminal, and sending the link(s) of the subpage(s) other than the first subpage to the user terminal, so that the user terminal browses the web page according to the first subpage and the link(s).

Prior to the acquiring a web page requested by a user terminal, the method further includes:

upon receiving a request for browsing the web page from the user terminal, acquiring the number of bytes per subpage as predetermined by the user terminal in the request for browsing the web page.

The dividing the web page into at least two subpages specifically includes:

calculating a first number of bytes on the web page requested by the user terminal, where the first number of bytes is the number of bytes on the web page; and

when the first number of bytes is larger than the predetermined number of bytes per subpage, dividing, according to the first number of bytes and the predetermined number of bytes per subpage, the web page requested by the user terminal into at least two subpages, where the number of bytes of any of the subpages is smaller than or equal to the predetermined number of bytes per subpage.

The dividing the web page into at least two subpages specifically includes:

calculating a second number of bytes on the web page requested by the user terminal, where the second number of bytes is the number of bytes on the web page experiencing predetermined conversion and compression; and

dividing, according to the predetermined number of bytes per subpage and the second number of bytes, the web page requested by the user terminal into at least two subpages, where the number of bytes of any of the subpages is smaller than or equal to the predetermined number of bytes per subpage.

After the sending a first subpage of the at least two subpages to the user terminal, and sending the link(s) of the subpage(s) other than the first subpage to the user terminal, the method includes:

upon receiving a request for browsing the subpage(s) other than the first subpage from the user terminal, sending the subpage(s) other than the first subpage to the user terminal.

In another aspect, a method for browsing web pages is provided, including:

sending a request for browsing a web page to a server, where the request carries the number of bytes as predetermined per subpage;

receiving a first subpage and the link(s) of subpage(s) other than the first subpage from the server; and

browsing the web page according to the first subpage and the link(s) of the subpage(s) other than the first subpage.

After the receiving a first subpage and the link(s) of subpage(s) other than the first subpage from the server, the method further includes:

displaying the link(s) of the subpage(s) other than the first subpage on the first subpage.

The displaying the link(s) of the subpage(s) other than the first subpage on the first subpage specifically includes:

when the number of links of the subpages other than the first subpage is larger than a predetermined threshold, displaying a predetermined number of first few links of the links of the subpages other than the first subpage, and the last link of the links of the subpages other than the first subpage.

The browsing the web page according to the first subpage and the link(s) of the subpage(s) other than the first subpage specifically includes:

displaying the first subpage;

upon receiving a request for browsing the subpage(s) other than the first subpage, sending, according to the link(s) of the subpage(s) other than the first subpage, the request for browsing the subpage(s) other than the first subpage; and

upon receiving the subpage(s) other than the first subpage from the server, displaying the subpage(s) other than the first subpage.

In still another aspect, a device for browsing web pages is provided, including:

a first acquiring module, configured to acquire a web page requested by a user terminal;

a page dividing module, configured to divide the web page into at least two subpages when the number of bytes on the web page requested by the user terminal is larger than the number of bytes per page as predetermined by the user terminal; and

a sending module, configured to send a first subpage of the at least two subpages to the user terminal, and sending the link(s) of the subpage(s) other than the first subpage to the user terminal, so that the user terminal browses the web page according to the first subpage and the link(s).

The device further includes:

a second acquiring module, configured to, upon receiving a request for browsing the web page from the user terminal, acquire the number of bytes per subpage as predetermined by the user terminal in the request for browsing the web page.

The page dividing module includes:

a calculating unit, configured to calculate a first number of bytes on the web page requested by the user terminal, where the first number of bytes is the number of bytes on the web page; and

a page dividing unit, configured to, when the first number of bytes is larger than the predetermined number of bytes per subpage, divide, according to the first number of bytes and the predetermined number of bytes per subpage, the web page requested by the user terminal into at least two subpages, where the number of bytes of any of the subpages is smaller than or equal to the predetermined number of bytes per subpage.

The page dividing module includes:

a calculating unit, configured to calculate a second number of bytes on the web page requested by the user terminal, where the second number of bytes is the number of bytes on the web page experiencing predetermined conversion and compression; and

a page dividing unit, configured to divide, according to the predetermined number of bytes per subpage and the second number of bytes, the web page requested by the user terminal into at least two subpages, where the number of bytes of any of the subpages is smaller than or equal to the predetermined number of bytes per subpage.

The sending module is further configured to, upon receiving a request for browsing the subpage(s) other than the first subpage from the user terminal, send the subpage(s) other than the first subpage to the user terminal.

A server is provided, where the server includes the device for browsing web pages.

In yet still another aspect, a mobile terminal is provided, including:

a sending module, configured to send a request for browsing a web page to a server, where the request carries the number of bytes as predetermined per subpage;

a receiving module, configured to receive a first subpage and the link(s) of subpage(s) other than the first subpage from the server; and

a browsing module, configured to browse the web page according to the first subpage and the link(s) of the subpage(s) other than the first subpage.

The mobile terminal further includes: a display module, configured to display the link(s) of the subpage(s) other than the first subpage on the first subpage.

The display module is specifically configured to, when the number of links of the subpages other than the first subpage is larger than a predetermined threshold, display a predetermined number of first few links of the links of the subpages other than the first subpage, and the last link of the links of the subpages other than the first subpage.

The browsing module includes:

a display unit, configured to display the first subpage; and

a request sending unit, configured to, after the mobile terminal receives a request for browsing the subpage(s) other than the first subpage, send, according to the link(s) of the subpage(s) other than the first subpage, the request for browsing the subpage(s) other than the first subpage to the server;

where the display unit is further configured to, upon receiving the subpage(s) other than the first subpage from the server, display the subpage(s) other than the first subpage.

The mobile terminal is an MP3, a mobile phone, or a mobile storage device.

The technical solutions according to the embodiments of the present invention achieve the following beneficial effects:

According to the number of bytes in the page predetermined by a mobile terminal, a web page requested by the mobile terminal is divided into at least two sub-pages, and the web page is browsed by using sub-page as a unit. This not only prevents a case where browsing web pages consumes a large amount of memory and CPU of the mobile terminal operating system and improves the browsing speed and operation speed, but also saves network traffic of the mobile terminal.

### BRIEF DESCRIPTION OF THE DRAWINGS

To illustrate the technical solutions in the embodiments of the present invention or in the prior art more clearly, the following briefly describes the accompanying drawings required for describing the embodiments or the prior art. Apparently, the accompanying drawings in the following description merely show some embodiments of the present invention, and persons of ordinary skill in the art can derive other drawings from these accompanying drawings without creative efforts.

FIG. 1 is a flowchart of a method for browsing web pages according to an embodiment of the present invention;

FIG. 2 is a flowchart of another method for browsing web pages according to an embodiment of the present invention;

FIG. 3 is a flowchart of still another method for browsing web pages according to an embodiment of the present invention;

FIG. 4 is a flowchart of still yet another method for browsing web pages according to an embodiment of the present invention;

FIG. 5 is a schematic structural diagram of a device for browsing web pages according to an embodiment of the present invention;

FIG. 6 is a schematic structural diagram of another device for browsing web pages according to an embodiment of the present invention;

FIG. 7 is a schematic structural diagram of still another device for browsing web pages according to an embodiment of the present invention;

FIG. 8 is a schematic structural diagram of a mobile terminal according to an embodiment of the present invention;

FIG. 9 is a schematic structural diagram of another mobile terminal according to an embodiment of the present invention; and

FIG. 10 is a schematic structural diagram of still another mobile terminal according to an embodiment of the present invention.

### DETAILED DESCRIPTION OF THE EMBODIMENTS

To make the objectives, technical solutions, and advantages of the present invention clearer, the following describes the embodiments of the present invention in detail below with reference to the accompanying drawings.

The user terminal described in the embodiments of the present invention refers to a mobile terminal, which may be specifically a mobile terminal having a browser, such as an MP3, a mobile phone, or a mobile storage device.

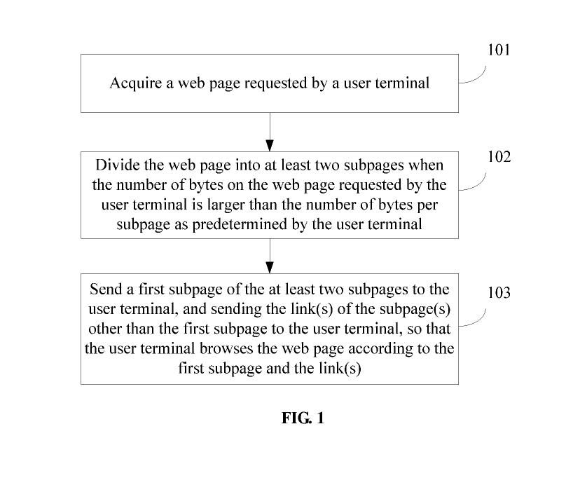

To improve the browsing speed and operation speed, and save network traffic of the mobile terminal, an embodiment of the present invention provides a method for browsing web pages. Referring to FIG. 1, the method includes:

101: acquiring a web page requested by a user terminal;

102: dividing the web page into at least two subpages when the number of bytes on the web page requested by the user terminal is larger than the number of bytes per subpage as predetermined by the user terminal; and

103: sending a first subpage of the at least two subpages to the user terminal, and sending the link(s) of the subpage(s) other than the first subpage to the user terminal, so that the user terminal browses the web page according to the first subpage and the link(s).

Prior to the acquiring a web page requested by a user terminal, the method further includes:

upon receiving a request for browsing the web page from the user terminal, acquiring the number of bytes per subpage as predetermined by the user terminal in the request for browsing the web page.

The dividing the web page into at least two subpages specifically includes:

calculating a first number of bytes on the web page requested by the user terminal, where the first number of bytes is the number of bytes on the web page; and

when the first number of bytes is larger than the predetermined number of bytes per subpage, dividing, according to the first number of bytes and the predetermined number of bytes per subpage, the web page requested by the user terminal into at least two subpages, where the number of bytes of any of the subpages is smaller than or equal to the predetermined number of bytes per subpage.

The dividing, according to the number of bytes per subpage as predetermined by the user terminal, the web page requested by the user terminal into at least two subpages specifically includes:

calculating a second number of bytes on the web page requested by the user terminal, where the second number of bytes is the number of bytes on the web page experiencing predetermined conversion and compression; and

dividing, according to the number of bytes per subpage as predetermined by the user terminal and the second number of bytes, the web page requested by the user terminal into at least two subpages, where the number of bytes of any of the subpages is smaller than or equal to the predetermined number of bytes per subpage.

After the sending a first subpage of the at least two subpages to the user terminal, and sending the link(s) of the subpage(s) other than the first subpage to the user terminal, the method includes:

upon receiving a request for browsing the subpage(s) other than the first subpage from the user terminal, sending the subpage(s) other than the first subpage to the user terminal.

According to the number of bytes in the page predetermined by a mobile terminal, a web page requested by the mobile terminal is divided into at least two sub-pages, and the web page is browsed by using sub-page as a unit. This not only prevents a case where browsing web pages consumes a large amount of memory and CPU of the mobile terminal operating system and improves the browsing speed and operation speed, but also saves network traffic of the mobile terminal.

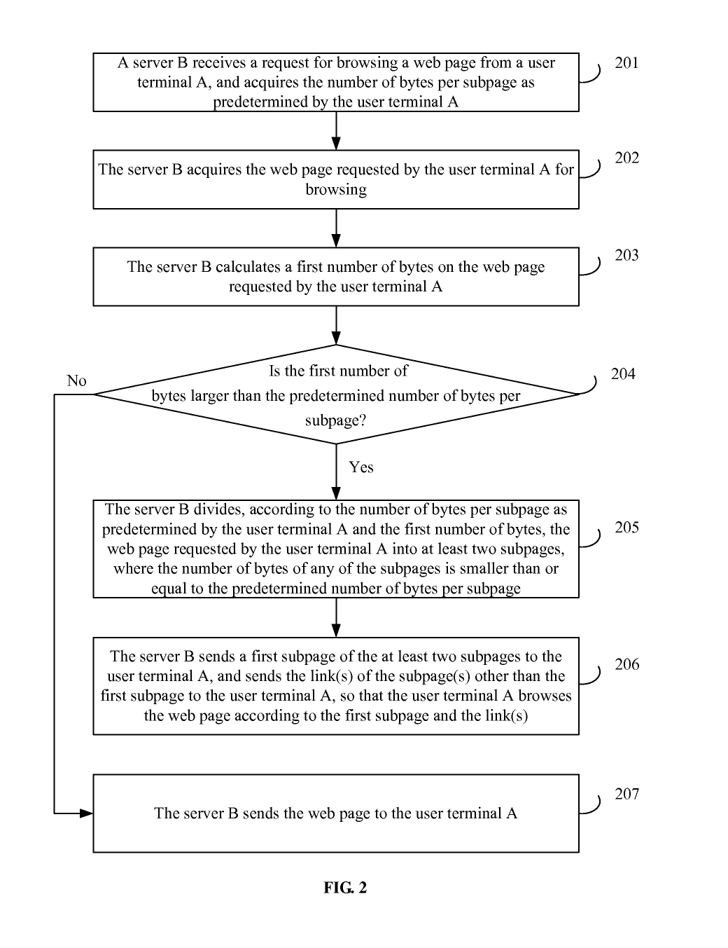

To improve the browsing speed and operation speed, and save network traffic of the mobile terminal, another embodiment of the present invention provides a method for browsing web pages. This embodiment uses interaction between a user terminal A and a server B as an example for description. Referring to FIG. 2, the method includes the following steps:

201: The server B receives a request for browsing a web page from the user terminal A, and acquires, from the request, the number of bytes per subpage as predetermined by the user terminal A.

In the embodiments of the present invention, the user terminal A sends a request for browsing a web page to the server B, where the request for browsing the web page carries the predetermined number of bytes. The request for browsing the web page is used to access a www web page. When the web page is browsed using the browser of a mobile terminal, the request is transferred by the server B. The server B is preferably a background server. The predetermined number of bytes carried in the request for browsing the web page may be selected by a user from a plurality of specifications on the number of bytes per subpage provided by the user terminal A. The plurality of specifications may be set by a developer according to factors such as screen size and processing speed. Preferably, the plurality of specifications may include 10 k, 20 k, 50 k and 100 k, which are not limited in the embodiments of the present invention.

In the embodiments of the present invention, since the request carries the number of bytes per subpage as predetermined by the user terminal A, the predetermined number of bytes per subpage needs to be extracted and stored so that further processing may be carried out in the subsequent browsing process according to the predetermined number of bytes per subpage.

Step 201 may be specifically as follows: The user terminal A sends a request for browsing a web page to the server B, where the request for browsing the web page carries a predetermined page specification; upon receiving the request, the server B acquires the predetermined page specification, acquires the number of bytes per subpage corresponding to the page specification according to a locally pre-stored corresponding relationship between the page specification and the number of bytes per subpage, and divides, according to the acquired number of bytes per subpage, the web page to be browsed in the following steps.

202: The server B acquires the web page requested by the user terminal A for browsing.

In the embodiments of the present invention, the server B responds to the request from the user terminal A, and acquires the web page requested for browsing from the request for browsing the web page. The web page may include HTML content, extensible HTML (XHTML) content, CSS, JS, pictures, and the like.

It should be noted that the step of acquiring the web page and step 201 of acquiring the predetermined number of bytes per subpage are not subject to a defined sequence, and these two steps need to be performed after the server B receives the request for browsing the web page and completed prior to step 203. To be specific, the acquiring the web page may be performed either prior to or after the acquiring the predetermined number of bytes per subpage, which is not limited in the embodiments of the present invention.

203: The server B calculates a first number of bytes on the web page requested by the user terminal A.

In the embodiments of the present invention, the calculating the first number of bytes on the web page requested by the user terminal A specifically includes: calculating the total number of bytes contained by data such as pictures and texts on the web page requested by the user terminal A.

Those skilled in the art can know that when a user terminal initiates a request for browsing a web page, both the request and the requested web page need to be transferred by a server, and the server acquires the web page according to the request.

204: The server B judges whether the first number of bytes is larger than the predetermined number of bytes per subpage; if greater, step 205 is performed; otherwise, step 207 is performed.

In the embodiments of the present invention, upon receiving the web page, the server B judges the number of bytes on the web page, and if the number of bytes is smaller, i.e., smaller than or equal to the predetermined number of bytes per subpage, the web page is considered suitable for the user terminal A to browse, and does not need to be divided into subpages. However, if the number of bytes is larger, i.e., larger than the predetermined number of bytes per sub page, the web page is considered unsuitable for the user terminal A to browse, and needs to be divided into subpages.

205: The server B divides, according to the number of bytes per subpage as predetermined by the user terminal A and the first number of bytes, the web page requested by the user terminal A into at least two subpages, where the number of bytes of any of the subpages is smaller than or equal to the predetermined number of bytes per subpage.

In the embodiments of the present invention, after traversing the web page, the server B calculates the size of the web page content. During calculation, the server B divides the web page according to the size of the web page content. The web page may be divided in a top-to-bottom sequence, and factors such as completeness of pictures may be considered during web page division. For example, during the web page division, one picture is arranged within one sub page to ensure that the web page can be smoothly and completely browsed by the user terminal A.

For example, when the first number of bytes is 2a+b, the predetermined number of bytes per subpage is a, and b<a, the web page may be divided into three sub pages: a first subpage with the number of bytes a, a second subpage with the number of bytes a, and a third subpage with the number of bytes b.

Further, to achieve a better browsing effect, during calculation of subpages, when the number of bytes of the last subpage is smaller than or equal to a predetermined ratio of the predetermined number of bytes per subpage, the last subpage is combined into the second subpage from the last. The predetermined ratio is preferably 10%.

In addition, the web page may have content whose link is identified by an HTML tag. For uninterrupted browsing of the content, during calculation of subpages, when the tail of the subpage is in the content of the predetermined tag, the content contained in the predetermined tag is combined into a previous subpage.

Preferably, the predetermined tag may be any one of <A>, <OPTGROUP>, <SELECT>, and <SELECT>.

206: The server B sends a first subpage of the at least two subpages to the user terminal A, and sends the link(s) of the subpage(s) other than the first subpage to the user terminal A, so that the user terminal A browses the web page according to the first subpage and the link(s).

In the embodiments of the present invention, after web page division, the first subpage is sent to the user terminal A; the user terminal A displays the first subpage, and to save network traffic, sends the link(s) of the subpages other than the first subpage to the user terminal A. According to the locations of the subpages on the web page, the links thereof may be displayed as “page 2”, “page 3”, and the like. In addition, the link is displayed in the navigation bar on the user terminal interface, and the location of the navigation bar is set by the user terminal, which is variable with preferences of the user. Further, when the user terminal A needs to browse the subpage(s) other than the first subpage in the navigation bar, the user terminal A sends a request for browsing the subpage(s) other than the first subpage to the server B. Upon receiving the request from the user terminal A, the server B sends the subpage(s) other than the first subpage to the user terminal A.

207: The server B sends the web page to the user terminal A.

An embodiment of the present invention further provides a method for browsing web pages. Principles of the method are similar to those of the method described in steps 201 to 207. The difference lies in that, during calculation of the number of bytes in a web page, the second number of bytes on the web page requested by the user terminal is calculated, where the second number of bytes on the web page is the number of bytes experience preset conversion and compression. The preset conversion and compression refers to preset conversion and compression for pictures on the web page. Specifically, the second number of bytes is the number of bytes of original HTML contents and pictures experiencing preset conversion and compression on the web page. The server B judges whether the second number of bytes is greater than the number of bytes in a sub-page; if larger, divides the web page requested by the user into at least two sub-pages according to the number of bytes in a sub-page preset by the user terminal A and the second number of bytes, where the number of bytes in any of the sub-pages is smaller than or equal to the preset number of bytes in a sub-page; and otherwise, sends the web page to the user terminal A.

According to the number of bytes in the page preset by a mobile terminal, a web page requested by the mobile terminal is divided into at least two sub-pages, and the web page is browsed by using sub-page as a unit. This not only prevents a case where browsing web pages consumes a large amount of memory and CPU of the mobile terminal operating system and improves the browsing speed and operation speed, but also saves network traffic of the mobile terminal.

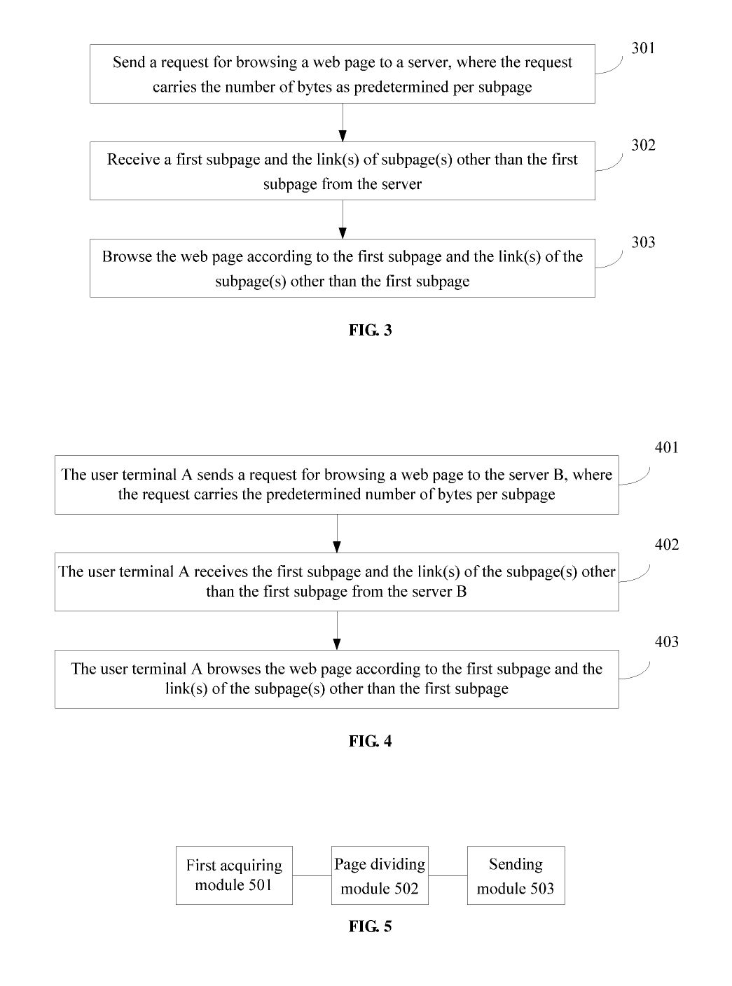

To improve the browsing speed and operation speed, and save network traffic of the mobile terminal, another embodiment of the present invention provides a method for browsing web pages. Referring to FIG. 3, the method includes:

301: sending a request for browsing a web page to a server, where the request carries the number of bytes as predetermined per subpage;

302: receiving a first subpage and the link(s) of subpage(s) other than the first subpage from the server; and

303: browsing the web page according to the first subpage and the link(s) of the subpage(s) other than the first subpage.

After the receiving a first subpage and the link(s) of subpage(s) other than the first subpage from the server, the method further includes:

displaying the links of the subpage(s) other than the first subpage on the first subpage.

The displaying the link(s) of the subpage(s) other than the first subpage on the first subpage specifically includes:

when the number of links of the subpages other than the first subpage is larger than a predetermined threshold, displaying a predetermined number of first few links of the links of the subpages other than the first subpage, and the last link of the links of the subpages other than the first subpage.

The browsing the web page according to the first subpage and the link(s) of the subpage(s) other than the first subpage specifically includes:

displaying the first subpage;

upon receiving a request for browsing the subpage(s) other than the first subpage, sending, according to the link(s) of the subpage(s) other than the first subpage, the request for browsing the subpage(s) other than the first subpage; and

upon receiving the subpage(s) other than the first subpage from the server, displaying the subpage(s) other than the first subpage.

According to the number of bytes in the page predetermined by a mobile terminal, a web page requested by the mobile terminal is divided into at least two sub-pages, and the web page is browsed by using sub-page as a unit. This not only prevents a case where browsing web pages consumes a large amount of memory and CPU of the mobile terminal operating system and improves the browsing speed and operation speed, but also saves network traffic of the mobile terminal.

To improve the browsing speed and operation speed, and save network traffic of the mobile terminal, another embodiment of the present invention provides a method for browsing web pages. The method is described by using a user terminal A as an execution subject, where the server corresponding to the user terminal A is a server B. The server B is configured to transfer a request for browsing a web page from the user terminal A, and transfer the requested web page to the user terminal A. Referring to FIG. 4, the method includes the following steps:

401: The user terminal A sends a request for browsing a web page to the server B, where the request carries the predetermined number of bytes per subpage.

The request for browsing the web page is used to access a WWW web page. When the web page is browsed by using the browser of a mobile terminal, the request for browsing the web page is transferred by the server B. The server B is preferably a background server. The predetermined number of bytes carried in the request for browsing the web page may be selected by a user from a plurality of specifications on the number of bytes per subpage provided by the user terminal. The plurality of specifications may be set by a developer according to factors such as screen size and processing speed. Preferably, the plurality of specifications may include 10 k, 20 k, 50 k and 100 k, which are not limited in the embodiments of the present invention.

For example, a model-A mobile phone has three types of web page division setting options: “big”, “medium”, and “small”. The specifications corresponding thereto are 100 k, 50 k, and 20 k respectively. When the user selects “big” on the user terminal, the predetermined number of bytes per subpage selected by the user is 100 k. To be specific, the number of bytes of the subpage displayed on the user terminal is 100 k.

In the embodiments of the present invention, upon receiving the request for browsing the web page from the user terminal A, the server B acquires the number of bytes per subpage as predetermined by the user terminal from the request, acquires the web page requested by the user terminal A for browsing, and calculates a first number of bytes on the web page requested by the user terminal A; the server B judges whether the first number of bytes is larger than the predetermined number of bytes per subpage; if larger, the server B divides, according to the number of bytes per subpage as predetermined by the user terminal and the first number of bytes, the web page requested by the user terminal into at least two subpages, where the number of bytes of any of the subpages is smaller than or equal to the predetermined number of bytes per subpage; the server B sends a first subpage of the at least two subpages to the user terminal, and sends the link(s) of the subpage(s) other than the first subpage to the user terminal, so that the user terminal browses the web page according to the first subpage and the link(s).

402: The user terminal A receives the first subpage and the link(s) of the subpage(s) other than the first subpage from the server B.

In the embodiments of the present invention, after web page division, the server B sends the first subpage and the link(s) of the subpage(s) other than the first subpage to the user terminal A; upon receiving the subpage and the link(s), the user terminal A displays the first subpage and the link(s), where the link(s) are displayed on the user terminal according to a predetermined form. To be specific, all the link(s) or the link of a next page may be displayed in the drop-down list of the navigation bar, or the display may vary with the display progress of the web page. For example, if page 2 is currently displayed, “page 3” is displayed in the navigation bar; and if the displayed page switches to page 3, “page 4” is correspondingly displayed in the navigation bar.

403: The user terminal A browses the web page according to the first subpage and the links of the subpages other than the first subpage.

In the embodiments of the present invention, after web page division, the server B sends the first subpage to the user terminal A; the user terminal A displays the first subpage, and to save network traffic, sends the link(s) of the subpages other than the first subpage to the user terminal A. According to the locations of the subpages on the web page, the links thereof may be displayed as “page 2”, “page 3”, and the like. In addition, the link is displayed in the navigation bar on the user terminal interface, and the location of the navigation bar is set by the user terminal, which is variable with preferences of the user. Alternatively, when the number of links of the subpages other than the first subpage is larger than a predetermined threshold, a preset number of first links of the links of the subpages other than the first subpage, and the last link of the links of the subpages other than the first subpage are displayed. For example, in the case that too much content needs to be displayed in a WWW web page, the web page may be divided into 20 subpages; if the 20 subpages are simultaneously displayed in the drop-down navigation bar of the subpage, the navigation bar may occupy too much HTMP data, and more importantly the effect of displaying subpage bar on the user terminal such as a mobile phone is affected. Therefore, the navigation bar may display “page 1”, “page 2”, “page 3”, “page 4”, “page 5”, and “page 6”. If the predetermined threshold is 8, and the last page is page 20, a line of ellipsis is displayed after “page 6”, and “page 20” is displayed in the next line. If the user needs to browse any one between page 6 and page 20, the user can switch pages by scrolling up or down using the cursor. When the cursor is located in page 6, and is scrolled down, the navigation bar displays the links of the pages, such as “page 7”.

Further, when the user terminal A needs to browse the subpage(s) other than the first subpage in the navigation bar, the user terminal A sends a request for browsing the subpage(s) other than the first subpage to the server B. Upon receiving the request from the user terminal A, the server B sends the subpage(s) other than the first subpage to the user terminal Specifically, when the link(s) of the subpage(s) other than the first subpage is (are) clicked by the user terminal A, the request for browsing the subpage(s) is sent to the server B. Upon receiving the request, the server B sends the corresponding subpage(s) to the user terminal A. Upon receiving the corresponding subpage(s), the user terminal displays the subpage(s) for browsing.

Those skilled in the art can know that flipping of the user terminal may be implemented by clicking keys, by scrolling up and down an indicator wheel, or by using preset direction keys.

According to the number of bytes in the page predetermined by a mobile terminal, a web page requested by the mobile terminal is divided into at least two sub-pages, and the web page is browsed by using sub-page as a unit. This not only prevents a case where browsing web pages consumes a large amount of memory and CPU of the mobile terminal operating system and improves the browsing speed and operation speed, but also saves network traffic of the mobile terminal.

To improve the browsing speed and operation speed, and save network traffic of the mobile terminal, another embodiment of the present invention provides a device for browsing web pages. Referring to FIG. 5, the device includes:

a first acquiring module 501, configured to acquire a web page requested by a user terminal;

a page dividing module 502, configured to divide the web page into at least two subpages when the number of bytes on the web page requested by the user terminal is larger than the number of bytes per page as predetermined by the user terminal; and

a sending module 503, configured to send a first subpage of the at least two subpages to the user terminal, and sending the link(s) of the subpage(s) other than the first subpage to the user terminal, so that the user terminal browses the web page according to the first subpage and the link(s).

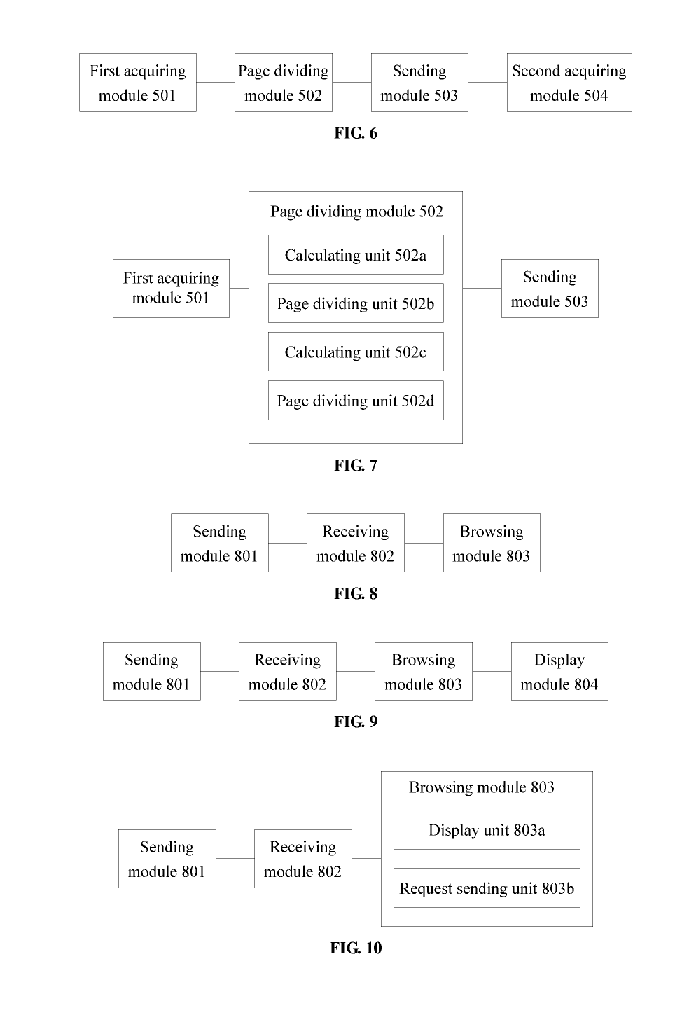

Referring to FIG. 6, the device includes:

a second acquiring module 504, configured to, upon receiving a request for browsing the web page from the user terminal, acquire the number of bytes per subpage as predetermined by the user terminal in the request for browsing the web page.

Referring to FIG. 7, the page dividing module 502 includes:

a calculating unit 502a, configured to calculate a first number of bytes on the web page requested by the user terminal;

a page dividing unit 502b, configured to, when the first number of bytes is larger than the predetermined number of bytes per subpage, divide, according to the first number of bytes and the predetermined number of bytes per subpage, the web page requested by the user terminal into at least two subpages, where the number of bytes of any of the subpages is smaller than or equal to the predetermined number of bytes per subpage.

The page dividing module 502 includes:

a calculating unit 502c, configured to calculate a second number of bytes on the web page requested by the user terminal, where the second number of bytes is the number of bytes on the web page experiencing predetermined conversion and compression; and

a page dividing unit 502d, configured to divide, according to the predetermined number of bytes per subpage and the second number of bytes, the web page requested by the user terminal into at least two subpages, where the number of bytes of any of the subpages is smaller than or equal to the predetermined number of bytes per subpage.

The sending module 503 is further configured to, upon receiving a request for the subpage(s) other than the first subpage from the user terminal, send the subpage(s) other than the first subpage to the user terminal.

The device provided in this embodiment and the method embodiments are based on the same concept. Therefore, the detailed implementation can refer to the description of the method embodiments of the present invention, which is not described herein any further.

Another embodiment of the present invention provides a server, where the server includes the above-described device for browsing web pages.

The server provided in this embodiment may be specifically an Internet browsing background server, and is based on the same concept as the method embodiments. Therefore, the detailed implementation can refer to the description of the method embodiments of the present invention, which is not described herein any further.

Another embodiment of the present invention provides a mobile terminal. Referring to FIG. 8, the mobile terminal includes:

a sending module 801, configured to send a request for browsing a web page to a server, where the request carries the number of bytes as predetermined per subpage;

a receiving module 802, configured to receive a first subpage and the link(s) of subpage(s) other than the first subpage from the server; and

a browsing module 803, configured to browse the web page according to the first subpage and the link(s) of the subpage(s) other than the first subpage.

Referring to FIG. 9, the mobile terminal further includes:

a display module 804, configured to display the link(s) of the subpage(s) other than the first subpage on the first subpage.

The display module 804 is specifically configured to, when the number of links of the subpages other than the first subpage is larger than a predetermined threshold, display a predetermined number of first few links of the links of the subpages other than the first subpage, and the last link of the links of the subpages other than the first subpage.

Referring to FIG. 10, the browsing module 803 includes:

a display unit 803a, configured to display the first subpage; and

a request sending unit 803b, configured to, after the mobile terminal receives a request for browsing the subpage(s) other than the first subpage, send, according to the link(s) of the subpage(s) other than the first subpage, the request for browsing the subpage(s) other than the first subpage to the server;

where the display unit 803a is further configured to, upon receiving the subpage(s) other than the first subpage from the server, display the subpage(s) other than the first subpage.

The mobile terminal provided in this embodiment may be specifically a mobile terminal having a browser, such as an MP3, a mobile phone, or a mobile storage device, and is based on the same concept as the method embodiments. Therefore, the detailed implementation can refer to the description of the method embodiments of the present invention, which is not described herein any further.

All or part of the technical solutions according to the embodiments of the present invention may be implemented by a program instructing relevant hardware. The program may be stored in a readable storage medium. The storage medium includes various mediums capable of storing program code, such as a read only memory (ROM), a random access memory (RAM), a magnetic disk, or a compact disc read-only memory (CD-ROM).

Described above are merely preferred embodiments of the present invention, but are not intended to limit the present invention. Any modification, equivalent replacement, or improvement made without departing from the spirit and principle of the present invention should fall within the protection scope of the present invention.

What is claimed is:

1. A method for browsing web pages, comprising:
acquiring a web page requested by a user terminal;
dividing the web page into at least two subpages when the number of bytes on the web page requested by the user terminal is larger than the number of bytes per subpage as predetermined by the user terminal; and
sending a first subpage of the at least two subpages to the user terminal, and sending the link(s) of the subpage(s) other than the first subpage to the user terminal, so that the user terminal browses the web page according to the first subpage and the link(s).

2. The method according to claim 1, wherein prior to the acquiring a web page requested by a user terminal, the method further comprises:
upon receiving a request for browsing a web page from the user terminal, acquiring the number of bytes per subpage as predetermined by the user terminal in the request for browsing the web page.

3. The method according to claim 1, wherein the dividing the web page into at least two subpages specifically comprises:
calculating a first number of bytes on the web page requested by the user terminal, wherein the first number of bytes is the number of bytes on the web page; and
when the first number of bytes is larger than the predetermined number of bytes per subpage, dividing, according to the first number of bytes and the predetermined number of bytes per subpage, the web page requested by the user terminal into at least two subpages, wherein the number of bytes of any of the subpages is smaller than or equal to the predetermined number of bytes per subpage.

4. The method according to claim 1, wherein the dividing the web page into at least two subpages specifically comprises:
calculating a second number of bytes on the web page requested by the user terminal, wherein the second number of bytes is the number of bytes on the web page experiencing predetermined conversion and compression; and
dividing, according to the predetermined number of bytes per subpage and the second number of bytes, the web page requested by the user terminal into at least two subpages, wherein the number of bytes of any of the subpages is smaller than or equal to the predetermined number of bytes per subpage.

5. The method according to claim 1, wherein after the sending a first subpage of the at least two subpages to the user terminal, and sending the link(s) of the subpage(s) other than the first subpage to the user terminal, the method further comprises:
upon receiving a request for browsing the subpage(s) other than the first subpage from the user terminal, sending the subpage(s) other than the first subpage to the user terminal.

6. A method for browsing web pages, comprising:
sending a request for browsing a web page to a server, wherein the request carries the number of bytes as predetermined per subpage;
receiving a first subpage and the link(s) of subpage(s) other than the first subpage from the server; and
browsing the web page according to the first subpage and the link(s) of the subpage(s) other than the first subpage.

7. The method according to claim 6, wherein after the receiving a first subpage and the link(s) of subpage(s) other than the first subpage from the server, the method further comprises:
displaying the link(s) of the subpage(s) other than the first subpage on the first subpage.

8. The method according to claim 7, wherein the displaying the link(s) of the subpage(s) other than the first subpage on the first subpage specifically comprises:
when the number of links of the subpages other than the first subpage is larger than a predetermined threshold, displaying a predetermined number of first few links of the links of the subpages other than the first subpage, and the last link of the links of the subpages other than the first subpage.

9. The method according to claim 6, wherein the browsing the web page according to the first subpage and the link(s) of the subpage(s) other than the first subpage specifically comprises:
displaying the first subpage;
upon receiving a request for browsing the subpage(s) other than the first subpage, sending, according to the link(s) of the subpage(s) other than the first subpage, the request for browsing the subpage(s) other than the first subpage; and
upon receiving the subpage(s) other than the first subpage from the server, displaying the subpage(s) other than the first subpage.

10. A device for browsing web pages, comprising:
a first acquiring module, configured to acquire a web page requested by a user terminal;
a page dividing module, configured to divide the web page into at least two subpages when the number of bytes on the web page requested by the user terminal is larger than the number of bytes per page as predetermined by the user terminal; and
a sending module, configured to send a first subpage of the at least two subpages to the user terminal, and sending the link(s) of the subpage(s) other than the first subpage to the user terminal, so that the user terminal browses the web page according to the received first subpage and the link(s).

11. The device according to claim 10, further comprising:
a second acquiring module, configured to, upon receiving a request for browsing the web page from the user terminal, acquire the number of bytes per subpage as predetermined by the user terminal in the request for browsing the web page.

12. The device according to claim 10, wherein the page dividing module comprises:
a calculating unit, configured to calculate a first number of bytes on the web page requested by the user terminal, wherein the first number of bytes is the number of bytes on the web page; and
a page dividing unit, configured to, when the first number of bytes is larger than the predetermined number of bytes per subpage, divide, according to the first number of bytes and the predetermined number of bytes per subpage, the web page requested by the user terminal into at least two subpages, wherein the number of bytes of any of the subpages is smaller than or equal to the predetermined number of bytes per subpage.

13. The device according to claim 10, wherein the page dividing module comprises:
a calculating unit, configured to calculate a second number of bytes on the web page requested by the user terminal, wherein the second number of bytes is the number of bytes on the web page experiencing predetermined conversion and compression; and
a page dividing unit, configured to divide, according to the predetermined number of bytes per subpage and the second number of bytes, the web page requested by the user terminal into at least two subpages, wherein the number of bytes of any of the subpages is smaller than or equal to the predetermined number of bytes per subpage.

14. The device according to claim 10, the sending module is further configured to, upon receiving a request for browsing the subpage(s) other than the first subpage from the user terminal, send the subpage(s) other than the first subpage to the user terminal.

15. A server, comprising a device for browsing a web page according to claim 10.

16. A mobile terminal, comprising:
a sending module, configured to send a request for browsing a web page to a server, wherein the request carries the number of bytes as predetermined per subpage;
a receiving module, configured to receive a first subpage and the link(s) of subpage(s) other than the first subpage from the server; and
a browsing module, configured to browse the web page according to the first subpage and the link(s) of the subpage(s) other than the first subpage.

17. The mobile terminal according to claim 16, further comprising: a display module, configured to display the link(s) of the subpage(s) other than the first subpage on the first subpage.

18. The mobile terminal according to claim 17, wherein the display module is specifically configured to, when the number of links of the subpages other than the first subpage is larger than a predetermined threshold, display a predetermined number of first few links of the links of the subpages other than the first subpage, and the last link of the links of the subpages other than the first subpage.

19. The mobile terminal according to claim 16, wherein the browsing module comprises:
a display unit, configured to display the first subpage; and
a request sending unit, configured to, after the mobile terminal receives a request for browsing the subpage(s) other than the first subpage, send, according to the link(s) of the subpage(s) other than the first subpage, the request for browsing the subpage(s) other than the first subpage to the server;
wherein the display unit is further configured to, upon receiving the subpage(s) other than the first subpage from the server, display the subpage(s) other than the first subpage.

20. The mobile terminal according to claim 16, wherein the mobile terminal is an MP3, a mobile phone, or a mobile storage device.
